(19) United States
(12) Patent Application Publication
(10) Pub. No.: US 2016/0348494 A1
(43) Pub. Date: Dec. 1, 2016

(54) Process for monitoring an intervention in a fluid exploitation well located underground, and related intervention device

(71) Applicant: TOTAL SA, Courbevoie (FR)

(72) Inventor: Pierre Chuilon, Rambouillet (FR)

(21) Appl. No.: 15/116,683

(22) PCT Filed: Feb. 5, 2015
(86) PCT No.: PCT/EP2015/052407

§ 371 Date: Aug. 4, 2016

(30) Foreign Application Priority Data
Feb. 5, 2014 (FR) 14 50871

(51) Int. Cl. E21B 47/00; G06F 17/50; E21B 47/14; E21B 47/022; E21B 47/06; E21B 47/12

(52) U.S. Cl. CPC E21B 47/0006; E21B 47/065; E21B 47/123; E21B 47/14; E21B 47/022; G06F 17/5009; E21B 43/26

(57) ABSTRACT

A process of monitoring the intervention of, an instrumented rod with at least one sensor for measuring a strain field along the rod, into the wall and measuring the strain field along the rod in a plurality of given shapes of evolution of the rod during the intervention. The process calculates a simulated strain field for each given shape of the rod, based on at least one first model taking account of the predetermined geometry of the well and the first model being able to determine a local buckling of the rod in the well. Further, the process compares the measured strain field and the simulated strain field in each given shape of evolution of the rod.

The present invention relates to a process for monitoring an intervention in a fluid exploitation well located underground, including the following steps:

intervention, from the surface, using an instrumented rod introduced into the well, the rod comprising at least one sensor for measuring a strain field along the rod;

measuring the strain field along the rod in a plurality of given shapes of evolution of the rod during the intervention.

Such a process is intended to follow the advancement of an intervention in the well, done using an instrumented rod.

The intervention is for example a measuring campaign, in which a diagraphic probe is lowered into a well arranged in the subsoil, in order to collect measurements relative to the structure of the well, formations situated across from the well, or other wells in the vicinity of that in which the measurement is done.

The process particularly applies to wells having inclined and/or horizontal segments, for which it is important to verify the progression of the diagraphic probe in the well, and optionally to determine its position in the well very precisely.

To lower a diagraphic probe into a well, it is known to mount the probe at the end of a composite rod formed by structural fibers embedded in a polymer matrix. The composite rod, provided with the probe, is pushed into the well, for example by using a hydraulic injection head located at the wellhead.

The use of a rod has the advantage of being relatively inexpensive and limiting, or even eliminating, the disruption on the exploitation of the well.

During the lowering of the rod, the friction between the rod and the wall of the well gradually increases the strains inside the rod.

Beyond a certain strain, the rod undergoes a sinusoidal buckling phenomenon, which increases the friction, until it undergoes a helical buckling, in which the friction is quite significant.

In some cases, in particular when the well segment is inclined, or even horizontal, the rod becomes blocked. The maximum offset achieved by the diagraphic probe is then limited, which reduces the interest of this transportation mode.

To monitor the advancement of the lowering of the rod, the operator generally monitors the length of unwound rod, and the tension applied on the rod.

Preferably, the rod and/or the diagraphic probe is provided with an accelerometer to determine whether the tool is still advancing. On the surface, the measurement of the oil pressure of the hydraulic system provides an idea of the friction involved.

These parameters are insufficient, however, to determine and localize the friction zones that may prove problematic, since the rod may continue to unwind on the surface, but without advancing in a corresponding manner at the bottom of the well.

WO 2006/003477 describes an instrumented composite rod comprising a central optical fiber arranged in a central metal tube and a plurality of peripheral optical fibers arranged in another metal tube. The tubes are placed in a central duct arranged in the composite matrix.

The peripheral fibers are used to determine the strains and curvature along a well arranged in the subsoil.

However, in no case is the exact geometry of the rod in the well determined.

Likewise, US 2009/0116000 describes the measurement of the shape of a well from strain measurements of several optical fibers distributed at the periphery of an elongate element introduced into the well. This document does not provide for monitoring or determining the exact geometry of the elongate element in the well.

In both of these documents, the geometry of the well is not known during the introduction of the rod.

One aim of the invention is to improve the real-time monitoring of an intervention done in a well using a rod, in order to optimize the use of the rod and for example increase the maximum offset obtained during its deployment in the well.

To that end, the invention relates to a process of the aforementioned type, characterized in that the process includes the following steps:

calculating a simulated strain field, for each given shape of the rod, based on at least one first model taking account of the predetermined geometry of the well, the first model being able to determine a local buckling of the rod in the well;

comparing the measured strain field and the simulated strain field in each given shape of evolution of the rod.

The process according to the invention may comprise one or more of the following features, considered alone or according to any technically possible combination(s):

the intervention includes gradually lowering the rod into the well, each given shape of evolution corresponding to an increasing length of the rod introduced into the well;

the local buckling of the rod is chosen from among a sinusoidal buckling and a helical buckling;

the first model takes account of environmental parameters of the well, in particular parameters relative to the fluid present in the well, and/or the wall defining the well;

the first model takes account of geometric and mechanical parameters of the rod, in particular its diameter, its linear weight, its modulus and/or its inertia;

the first model takes account of the geometric position of the measuring sensor in the rod;

it includes a prior step for calibrating the first model including the following phases:
placing the rod in a known geometric configuration, advantageously outside the well,
measuring the strain field along the rod, in the known geometric configuration,
calculating a theoretical geometric configuration of the rod, based on the measured strain field,
making a comparison between the known geometric configuration and the theoretical geometric configuration, and
adjusting at least one parameter of the first model based on said comparison;

during the adjusting step, the adjusted parameter is representative of the geometric position of the measuring sensor in the rod;

it includes, after measuring the strain field in the given shape of evolution, a step for determining the local geometry of the rod in the well based on the measured strain field;

the step for determining the local geometry of the rod includes calculating the exact position of a determined point of the rod, in particular an end of the rod, in the well based on the reconstituted local geometry of the rod;

the comparison step includes defining an admissible strain field envelope, based on the simulated strain field, and determining an outlet of the strain field measured outside the admissible strain field envelope;

it includes providing a composite instrumented rod comprising structural fibers and a matrix embedding the structural fibers, the measuring sensor comprising at least three optical fibers spaced angularly apart around the axis of the rod, embedded in the matrix;

the instrumented rod bears a probe for measuring physical or chemical parameters, in particular seismic data, and/or a camera;

the intervention includes a first lowering of the instrumented rod into the well to a first given shape of the rod, comparing the measured strain fields and the simulated strain field in the first given shape of the rod, then raising the instrumented rod outside the well,

the process next including equipping the rod with trajectory correction equipment, then a second lowering of the instrumented rod into the well.

The invention also relates to a device for intervention in a fluid exploitation well located underground, including:

an instrumented rod able to be introduced into the well, the rod comprising at least one sensor for measuring a strain field along the rod in a plurality of shapes of evolution of the rod in the well;

characterized in that the device includes a unit for monitoring the intervention comprising:

a module for simulating a calculated strain field, in each given shape of the rod, based on at least a first model taking account of the geometry of the well, the first model being able to determine a local buckling of the rod in the well;

a module for comparing the measured strain field and the simulated strain field in each given shape.

The invention will be better understood upon reading the following description, provided solely as an example and done in reference to the appended drawings, in which:

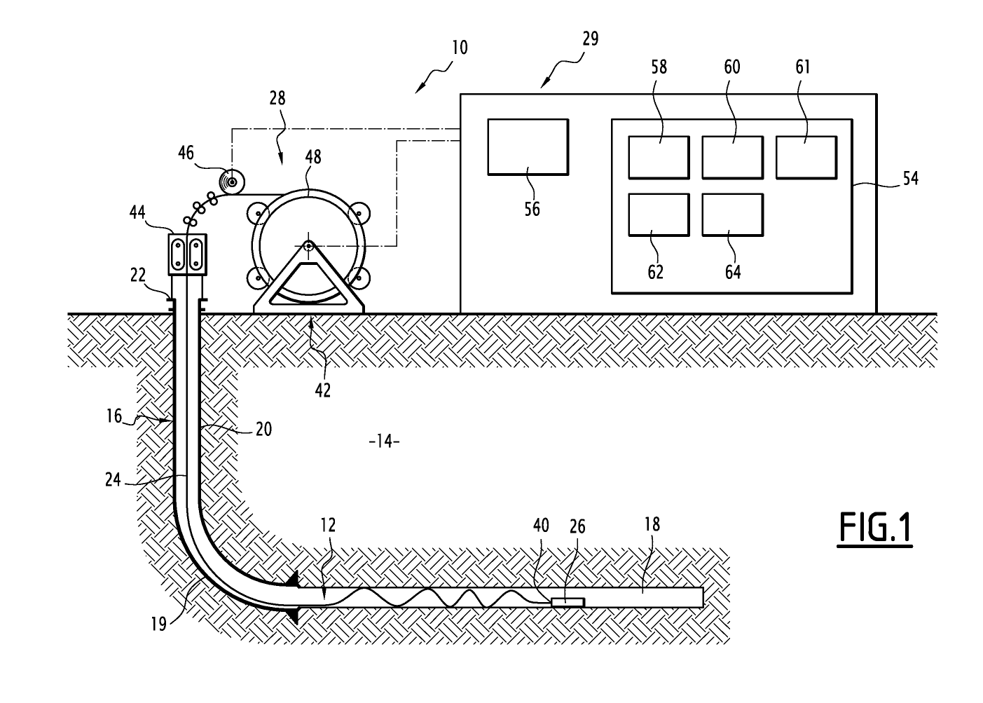

FIG. 1 is a diagrammatic partial sectional view of a device for intervention in a well, during the implementation of a first monitoring process according to the invention;

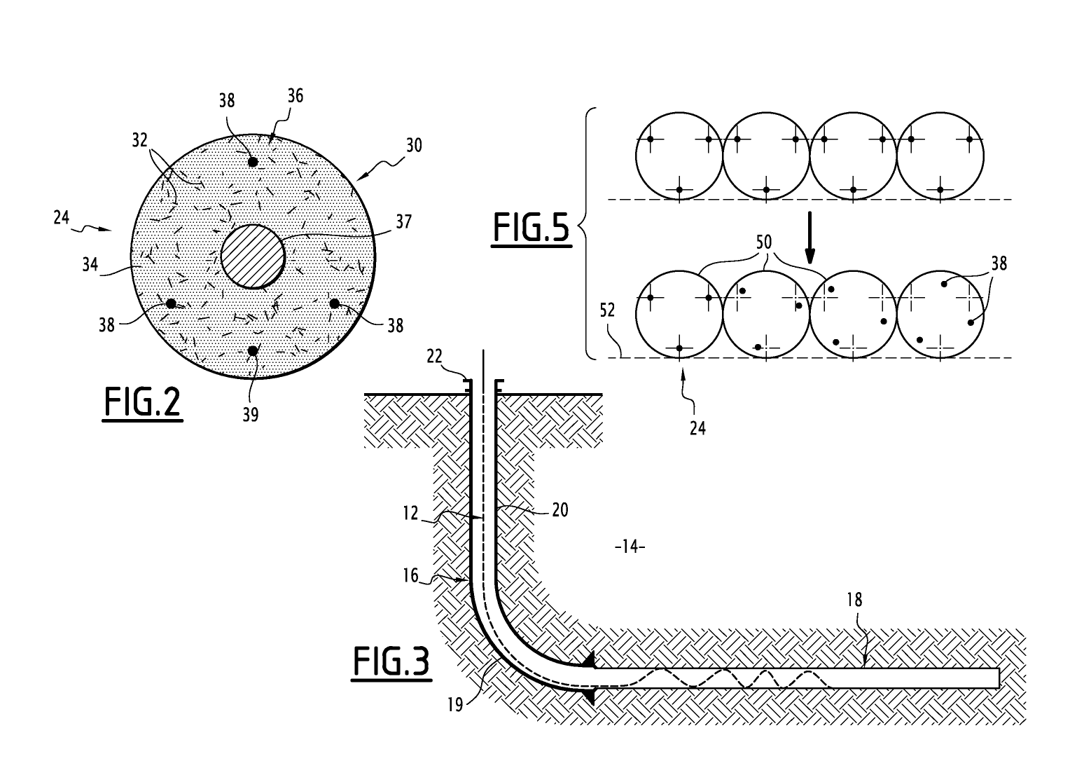

FIG. 2 is a cross-sectional view of an instrumented rod in the device of FIG. 1;

FIG. 3 is a view similar to FIG. 1, illustrating a simulation step during the implementation of the monitoring process according to the invention;

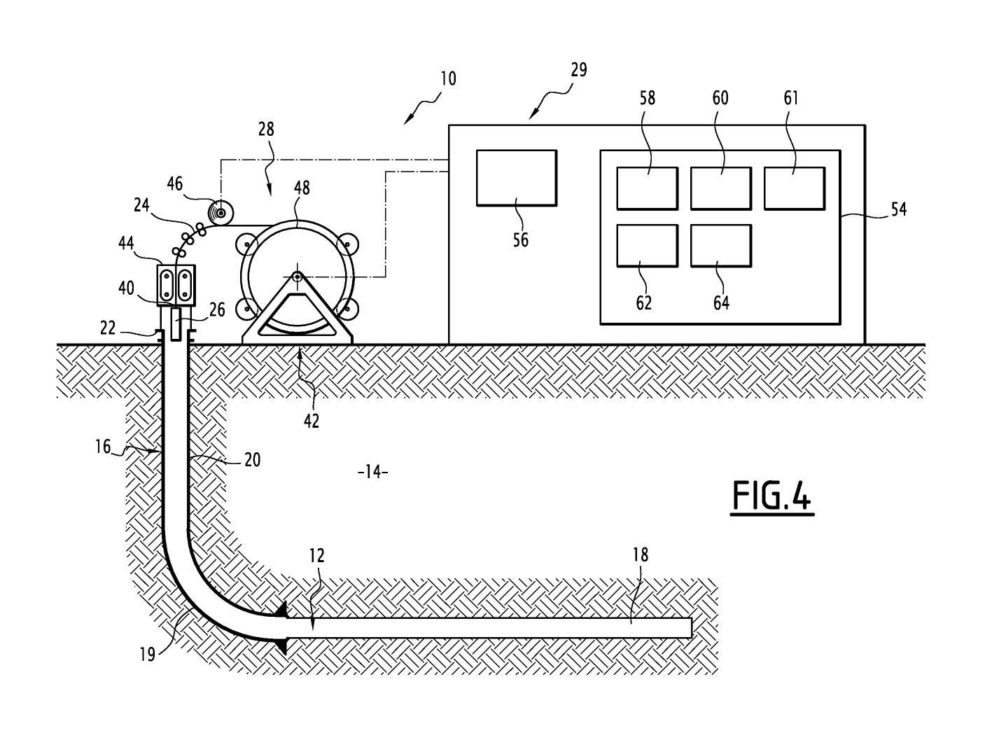

FIG. 4 is a view similar to FIG. 1, illustrating a calibration step during the implementation of the monitoring process according to the invention;

FIG. 5 is a sectional view in a median axial plane of the successive turns of the rod wound on a drum in an ideal theoretical configuration, and in a real configuration;

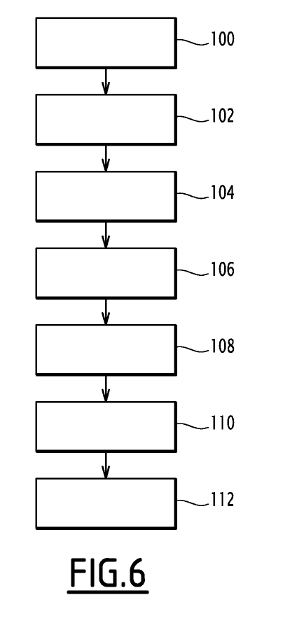

FIG. 6 is a flowchart illustrating successive steps of the monitoring process according to the invention.

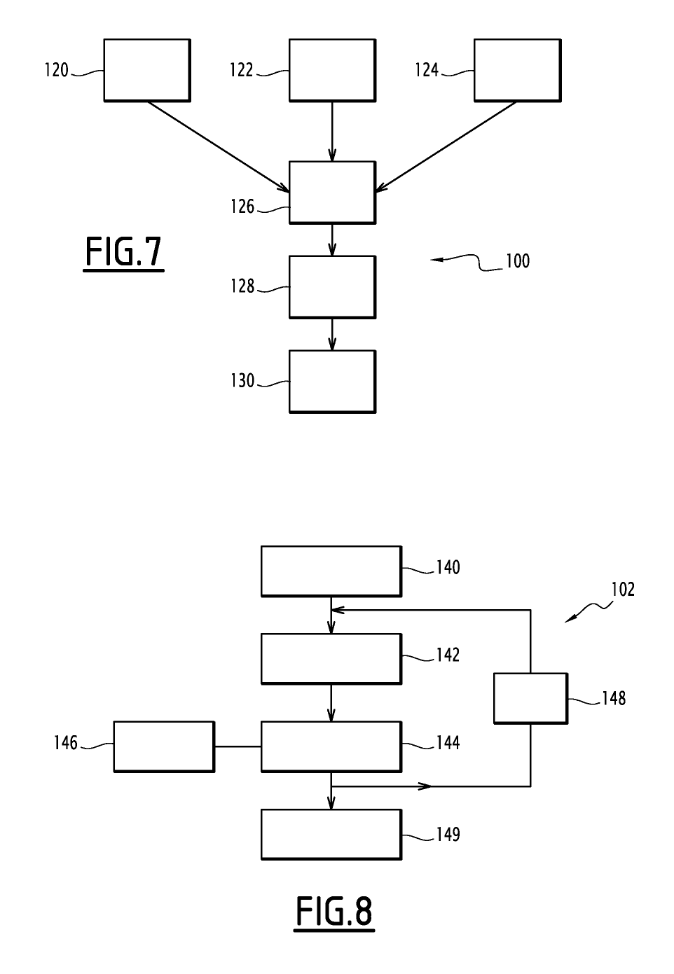

FIG. 7 is a flowchart illustrating the successive phases of the simulation step;

FIG. 8 is a flowchart illustrating the successive phases of the calibration step;

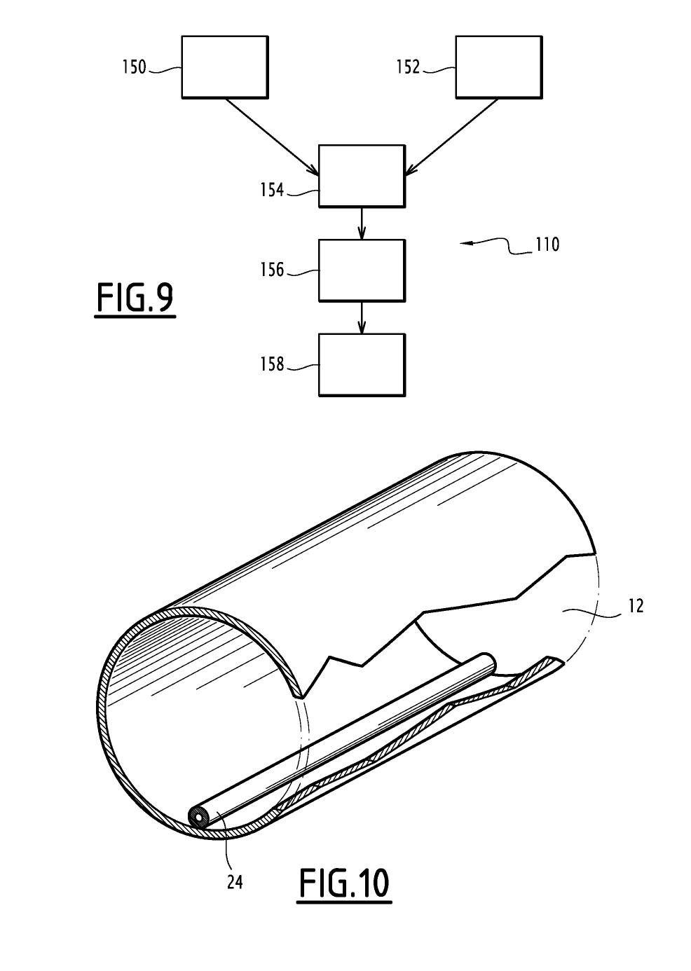

FIG. 9 is a flowchart illustrating the successive phases of the step for determining the exact position of the rod in the well;

FIGS. 10 to 12 are perspective views illustrating different local geometric configurations of the rod in the well;

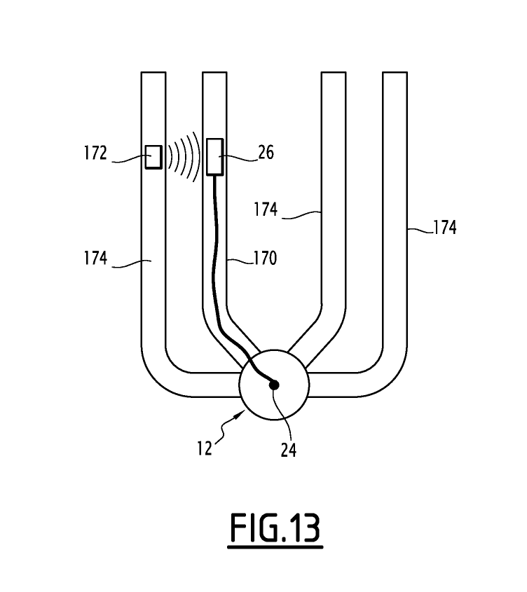

FIG. 13 is a diagrammatic view of the monitoring device during the implementation of an alternative monitoring process according to the invention, in a well comprising a plurality of parallel channels.

An example device 10 for implementing a first process according to the invention is illustrated in FIGS. 1 to 4.

The process is intended to monitor an intervention in a well 12, visible in FIGS. 1, 3 and 4.

The well 12 is made in the subsoil 14 through formations of the subsoil 14.

In this example, it includes a vertical segment 16, an inclined or horizontal segment 18, and a transitional segment 19 connecting the segments 16, 18.

Part of the well 12, in particular the vertical segment 16, here is provided with a metal casing 20. Another part of the well 12, in particular the inclined or horizontal segment 16, is defined directly by the formation.

The well 12 is closed at the surface of the subsoil 14 by a wellhead 22.

The well 12 has known geographical and dimensional characteristics when implementing the process. These characteristics in particular include, for each abscissa considered linearly along the well 12, an incline and an azimuth. They also include an inner hole diameter, or an inner diameter of the casing 20 when the latter is present.

The length of the well 12 is generally comprised between 300 m and 3500 m. The length of the well 12 is for example comprised between 1000 m and 5000 m.

In reference to FIG. 1, the device 10 includes an instrumented rod 24, deployable in the well 12, a probe 26 carried by the rod 24, and an assembly 28 for moving the rod 24 to cause it to evolve in the well 12, by being lowered or raised.

According to the invention, the device 10 further includes a unit 29 for monitoring the intervention, connected to the rod 24 and the movement assembly 28.

FIG. 2 illustrates an example cross-section of the instrumented rod 24.

As illustrated in this figure, the rod 24 includes an elongate body 30 comprising structural fibers 32 embedded in a polymer matrix 34.

It further includes at least one longitudinal sensor 36 for measuring a strain field along the local axis of the rod 24, preferably in a plurality of longitudinal positions along the rod 24.

The rod 24 advantageously includes a power line 37 and/or communication line with the probe 26, preferably arranged at the center of the rod 24.

The structural fibers 34 are for example carbon fibers or glass fibers. The polymer matrix 34 is for example made with a base of an epoxy resin or vinyl ester.

The matrix 34 is preferably made by pultrusion on the structural fibers 34.

The longitudinal sensor 36 advantageously includes optical fibers 38, which are distributed by the structural fibers 34 of the rod 24.

In this example, the longitudinal sensor 36 includes three optical fibers 38 spaced angularly apart and advantageously distributed at 120° around the axis A-A′ of the rod 24, to measure the strain field of each fiber 38.

It comprises at least one optical fiber 39 for measuring the temperature, arranged between the fibers 38 for measuring the strain field. These measurements are done from Bragg arrays formed in the fibers and/or by Brillouin spectrometry and/or by Raman spectrometry.

The optoelectronic measurement units (laser, interferometer, etc.) are located on the surface, for example in the unit 29.

The optical fibers 38 are embedded in the matrix 34 while being situated at a distance from the periphery of the matrix 34.

The rod 24 has a diameter smaller than 25 mm and advantageously comprised between 10 mm and 20 mm. It has a length greater than 1500 m, and in particular comprised between 2500 m and 5000 m.

The rod 24 is able to wind around the drum, with a minimal curve radius greater than 1 m.

It is elastically stressed toward a straight configuration. It has an axial rigidity allowing it to push the probe 26 during the lowering into the well 12, while retaining an appropriate flexibility to evolve in the segments 16 to 19 of the well 12.

The probe 26 is for example a diagraphic probe making it possible to take physical and/or chemical measurements along the wall of the well 12, for example to collect information relative to the formations traversed by the well 12.

This information is for example:
natural gamma ray or natural gamma ray spectrometries
litho density (Gamma-Gamma)
neutron porosity (Hydrogen Index) (Neutron-Neutron)
geochemical or elementary spectrometry (Neutron-Gamma)
acoustic, electrical
imaging (electrical, micro-acoustic, optical).

In the alternative shown in FIG. 16, the probe 26 is a geophysical streamer, able to collect seismic signals from operations done in wells 12 adjacent to that in which the probe 26 is circulating.

The probe 26 is fastened to the distal end 40 of the rod 24. It is for example provided with a tensiometer and/or an accelerometer to allow the operator on the surface to monitor its movement in the well 12.

The movement assembly 28 in this example includes a winch 42, a hydraulic and/or electric injection head 44 arranged at the wellhead 22, and a sensor 46 for measuring the length of rod 24 unwound off the winch 42.

The winch 42 includes a drum 48 and a mechanism (not shown) for hydraulic and/or electric driving of the drum 48 in rotation around its axis.

The rod 24 is able to wind on the drum 48 and unwind from the drum 48 during the rotation of the drum 48 in one direction or the other.

As illustrated by FIG. 5, the rod 24 forms regular turns 50 arranged adjacent to one another across from a peripheral surface 52 of the drum 48, shown in FIG. 5.

The hydraulic and/or electric injection head 44 is able to exert a longitudinal thrust force on the rod 24 to drive it toward the bottom of the well 12.

The measuring sensor 46 for example includes an instrumented pulley, around which the rod 24 is engaged.

The movement of the rod 24 rotates the pulley, which creates information representative of the unwinding or winding of the rod 24, sent to the monitoring unit 29.

The monitoring unit 29 is arranged on the surface, outside the well 12. It preferably includes a computer 54 including a memory and a processor, and a man-machine interface 56.

According to the invention, the monitoring unit 29 includes a software module 58 for recovering data, in particular data measured by the measuring sensor 36 arranged in the rod 24, and a software module 60 for simulating a simulated strain field applied on the rod 24.

The monitoring unit 29 further includes a software module 61 determining a measured strain field, based on data obtained from the measuring sensor 36 and a software module 62 for performing a comparison between the measured strain field and the simulated strain field.

The monitoring unit 29 advantageously includes a software module 64 for determining the exact position of a point of the rod 24, in particular the distal end 40 of the rod 24, to deduce the position of the probe 26 in the well 12 therefrom.

The modules 58 to 64 are preferably loaded in the memory of the computer 54 and are able to be executed by the processor during the intervention in the well 12.

The recovery module 58 is able to recover data relative to the structure of the well 12 and its environment. The module 58 is also able to recover structural data relative to the rod 24.

It is also able to load measuring data from the sensors 36, 46 connected to the monitoring unit 29, and in particular from the measuring sensor 36 arranged in the rod 24.

The data relative to the structure of the well 12 comprises the geographical coordinates of the well 12, in particular based on the abscissa along the local axis of the well. This data includes, for each abscissa, the incline and azimuth of the well 12. This data also includes the inner diameter of the hole, and the inner diameter of the casing 20 when it is present.

The data relative to the structure of the well 12 has been determined prior to the implementation of the process according to the invention, for example during the boring of the well 12, or during subsequent measuring campaigns.

The data relative to the environment of the well 12 comprises the density of the fluid present in the well 12, for example a sludge. The data relative to the environment further comprises the friction coefficient between the rod 24 and the casing 20 and/or the friction coefficient between the rod 24 and the formation surrounding the well 12.

This data has advantageously been determined outside the well 12, before implementation of the process according to the invention. Alternatively, this data is determined online in the well 12, during the intervention.

The structural data relative to the rod 24 for example includes dimensional data of the rod 24, such as its diameter, its linear density, and data relative to the mechanical properties of the rod 24, such as its elasticity modulus and its inertia.

This data has advantageously been determined outside the well 12, before implementation of the process according to the invention.

The measuring data is for example obtained from optoelectronic signals coming from optical fibers 38 of the sensor 36.

These optoelectronic signals are representative of the elongation or compression of each of the optical fibers 38 intended to measure the strain field, and the local temperature of the optical fiber 39 intended to measure the temperature.

This data is for example obtained for different measuring points distributed along the rod 24, for example with an interval smaller than 1.5 m.

For each measuring point, the measured data is recovered periodically over time, for a given shape of evolution of the rod 24 in the well 12, or periodically, for example at a frequency comprised between 0.015 Hz and 1 Hz.

The software simulation module 60 is able to determine, a priori, the local geometry along the well 12 and the internal strain field of the rod 24 in the well 12 for a plurality of given successive shapes of evolution of the rod 24 in the well 12, for example corresponding to the gradual lowering of the rod 24 into the well 12.

The software simulation module 60 is able to calculate, by simulation, a simulated strain field, in each shape of evolution of the rod 24, by implementing a first mathematical model taking into account known geometric data of the well 12, environmental data of the well 12, structural data of the rod 24, the model being able to determine the local buckling of the rod 24 in the well 12.

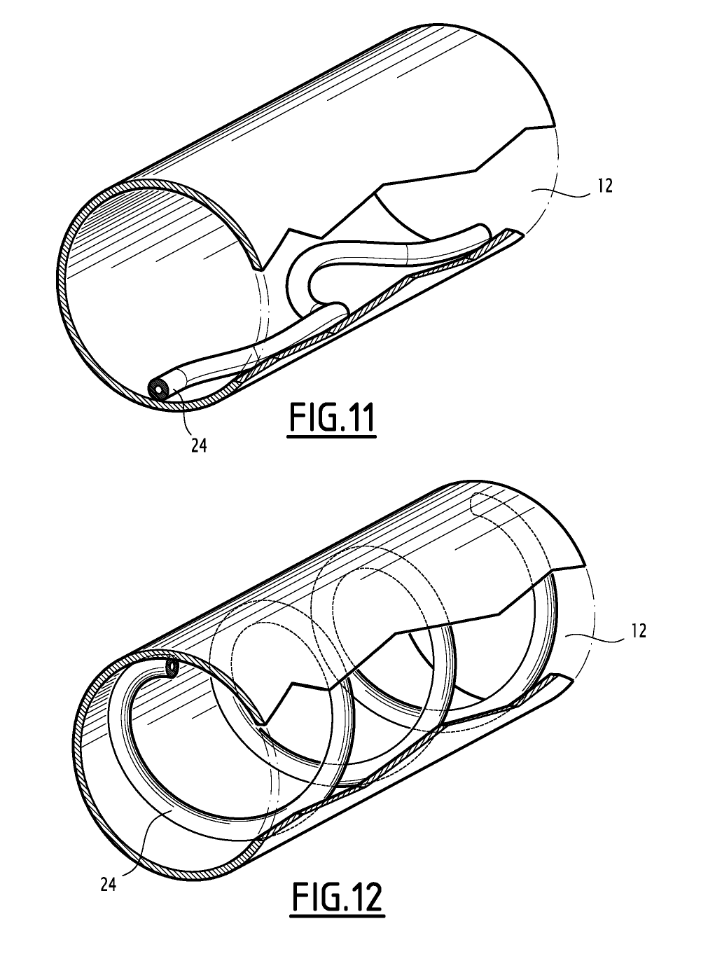

A first type of buckling consists of the passage from a straight local configuration, illustrated by FIG. 10, to a sinusoidal buckling configuration, illustrated in FIG. 11.

A second type of buckling consists of the passage from a sinusoidal buckling configuration to a helical buckling configuration, illustrated in FIG. 12.

In each step, the model determines whether the rod 24 may locally experience a sinusoidal buckling and/or a helical buckling, based on the strain simulated locally at a given point of the rod 24, based on the known geometry and environment of the well 12.

The model adapts the simulated local geometry of the rod 24 to respectively show a sinusoidal or helical buckling, and recalculates the calculated strain field locally applied on the rod 24.

Preferably, the model uses a numerical resolution of global equations and a contact algorithm.

Advantageously, one simple initial solution is defined by for example considering the rod 24 deployed in the well 12, without contact with the walls of the well 12, in particular in the lower side of the well 12. This solution is then disrupted by the iterative contact algorithm, in which successive points of contact are advantageously created from bottom to top, until convergence and obtainment of a final solution, equilibrium of the system.

The model is preferably based on the hypothesis that the rod is a flexible beam with predefined mechanical properties, the evolution of which is constrained in the tube defined by the walls of the well 12 with known dimensions, in a predefined environment present in the well 12.

The preliminary knowledge of the geometry of the well 12, the properties of the fluid present in the well 12, the friction coefficient between the rod 24 and the well 12 and the mechanical properties of the rod 24 allows the model to obtain the local geometry of the rod 24 over its entire length, by in particular determining any sinusoidal and/or helical buckling in each simulated shape.

Thus, the simulation module 60 is able to determine a plurality of successive simulated shapes of evolution of the rod 24 in the well 12 during the intervention, and to obtain, for each successive simulated shape, a simulated local geometry of the rod 24 in the well 12 taking account of any sinusoidal and/or helical buckling of the rod 24. One example simulated geometry is illustrated in dotted lines in FIG. 3.

Based on the simulated local geometry, and a second mathematical model, a simulated local strain field is obtained in each simulated shape of evolution.

The determination module 61 is able to determine, for each successive shape of evolution of the rod 24 in the well 12 during an intervention, a strain field measured over the length of the rod 26, based on the measuring data obtained from optoelectronic signals coming from optical fibers 38 of the sensor 36.

The comparison module 62 is able to collect the measured strain field obtained from the module 61 in each real shape of evolution of the rod 24 in the well 12 during the intervention and the simulated strain field in a simulated shape of evolution corresponding to the actual shape, obtained from the module 60.

The comparison for example includes a simultaneous display, side-by-side or superimposed, of the measured and simulated strain fields.

Alternatively, the comparison module 62 is able to define, from the simulated strain field in each simulated shape of evolution, an acceptable strain field envelope, then to determine whether the measured strain field leaves the acceptable envelope in each actual shape of evolution corresponding to the simulated shape.

When the measured strain shape leaves the acceptable envelope, a warning or an alarm is advantageously sent to the user.

The software determination module 64 is able to reconstruct a calculated geometric configuration of the rod 24 in the well 12, based on the strain field measured by the module 61 in each actual shape of evolution, using the second mathematical model.

The software determination module 64 is further able to calculate the exact position in the well 12 of at least one determined point of the rod 24, in particular the distal end 40 of the rod 24, based on the reconstituted local geometry of the rod 24.

The man-machine interface 56 advantageously includes a data entry and activation element of the unit 29, for example a keyboard or a touch-sensitive screen, and an information display element, for example a screen.

The screen is used to display the results obtained from the software comparison module 62, in graphic form, to allow the real-time monitoring of the intervention by an operator.

A first monitoring process according to the invention, implemented using the device 10, will now be described in reference to FIG. 6.

This process is described in the context of an intervention comprising lowering the rod 24 into the well 12, to bring the probe 26 to a measuring position.

During this lowering, the rod 24 occupies a plurality of successive shapes of evolution in the well 12, corresponding to increasing rod 24 lengths introduced into the well 12.

The process here includes a prior step 100 for calculating a simulated strain field in a plurality of simulated shapes of evolution of the rod 24 during the future intervention.

Next, before the intervention, the process advantageously includes a step 102 for calibrating the measurement done by the instrumented rod 24.

The process next includes a step 104 for intervention in the well 12, and in a plurality of shapes of evolution of the rod 24 during the intervention step 104, a step 106 for measuring a measured strain field, based on data obtained from the measuring sensor 36 arranged in the rod 24.

The process then includes, in each measured shape, a step 108 for comparison between the measured strain field and the simulated strain field, then optionally, a step 110 for determining the exact position of at least one point of the rod 24 in the well 12, in particular the distal end 40 of the rod 24.

The process then if necessary includes a step 112 for taking corrective action, based on the comparison done.

Initially, in step 100 illustrated by FIG. 7, the software simulation module 60 is activated to calculate the simulated strain field of the rod 24 in a plurality of simulated shapes of evolution, corresponding to increasing introduction lengths of the rod 24 into the well 12.

To that end, the software module 58 recovers trajectory data 120 of the well, in particular its incline and its azimuth based on the linear abscissa of the well, as well as the inner diameter of the well and any casing 20, environmental data 122 of the well 12, in particular the density of the fluid present in the well and the friction coefficient of the rod 24 on the casing 20 and on the formation, respectively.

The software module 58 also recovers structural data 124 of the rod 24, in particular its diameter, its linear mass, its mechanical modules, and its inertia.

During the phase 126, the data collected by the module 58 is sent to the simulation module 60 to implement, for each shape of evolution, a simulation of the local geometry of the rod 24 in the well 12 over its entire length using the first mathematical model.

As indicated above, the software module 60 implements a simulated lowering of the rod 24 into the well 12, based on the known geometry of the well 12 acquired by the module 58, up to the given shape.

In each step, the software module 60 thus determines whether the rod 24 may locally experience a sinusoidal buckling and/or a helical buckling, based on the known mechanical properties of the rod 24, and based on the known geometry and environment of the well 12.

The model determines the simulated local geometry of the rod 24 to show the sinusoidal or helical buckling, and recalculates the calculated strain field locally applied on the rod 24.

As indicated above, one simple initial solution is defined, then is disrupted by an iterative contact algorithm, in which successive points of contact are advantageously created from bottom to top, until convergence and obtainment of a final solution, equilibrium of the system.

After convergence of the model in phase 128, the exact local position of the rod 24 in the well 12 is obtained, as well as its trajectory in the well 12, in particular including sinusoidal or helical buckling, for each simulated configuration.

This local configuration is illustrated in dotted lines in FIG. 3.

Based on the obtained geometry, a simulated strain field is then calculated along the rod 24, in phase 130, for each simulated evolution configuration, using the second mathematical model.

Optionally, the software module 60 determines the simulated evolution configuration corresponding to the maximum offset of the rod 24 and the probe 26, beyond which no subsequent movement of the rod 24 and the probe 26 is possible.

Then, the calibration step 102 is carried out, as illustrated by FIG. 8. This step is preferably done on the surface, when the rod 24 is in a determined geometric configuration, for example while being wound on the drum of the winch 42.

This calibration step 102 in particular seeks to configure the mathematical models based on the exact geometric position of each optical fiber 38 of the longitudinal sensor 36 along the rod 24. As illustrated by FIG. 5, the real position of the fibers 38, embodied by dots, may vary relative to the presumed geometric position of the fibers 38, embodied by crosses, for example due to impressions or manufacturing flaws.

In order to determine the actual geometric position, step 102 includes a phase 140 for measuring the strain field along the rod 24 wound on the drum 48, then a phase 142 for determining the local geometry of the rod 24, based on the mathematical model defined above, from the measurement of the strain field.

The calibration step 102 next includes a phase 144 for a comparison between the local geometry of the rod 24 determined by calculation in phase 142, and the actual geometry 146 of the rod 24, as it is defined by the winding on the drum 48.

Next, if the convergence is not obtained, the calibration step 102 comprises a phase 148 for adjusting the presumed geometry of the fibers 38 before reproducing phases 142, 144.

Lastly, when a convergence is obtained in phase 149, the actual geometric position of the fibers 38 along the rod 24 is adjusted in the structural data 124.

Advantageously, a local heating system of the rod 24, such as a heating cover, is applied around the drum 48. The temperature of the rod 24 is then modified to adjust the parameters of each mathematical model based on the temperature, by causing the actual geometry of the rod 24 to converge with the geometry simulated by the model.

Next, the intervention step 104 is carried out. During this step, the rod 24 is gradually unwound from the winch 42 and is pushed into the well 12 by the hydraulic and/or electric injection head 44 so as to be synchronized with the unwinding from the winch 42.

An increasing length of the rod 24 is introduced into the well 12, to advance the probe 26 toward the bottom of the well 12.

A plurality of successive measurements 106 are done in the successive evolution configurations of the rod 24 in the well 12.

For each measuring step 106 corresponding to an evolution configuration of the rod 24, the measuring module 61 collects measuring data obtained from optoelectronic signals coming from the optical fibers 38 of the sensor 36 and calculates a measured strain field.

Optionally, a temperature correction is done to obtain a temperature-corrected measured strain field.

Then, in the comparison step 108, the module 62 compares the measured strain field, optionally temperature-corrected, with the simulated strain field calculated during step 100, in the simulated evolution configuration corresponding to the actual evolution configuration of the rod 24.

In a first embodiment, a direct comparison is done between the measured and simulated strain fields, for example by displaying them simultaneously, superimposed or side-by-side on a screen.

In another embodiment, the module 62 calculates an acceptable strain field envelope based on the simulated strain field and determines whether the measured strain field is entirely contained in the envelope.

When a deviation between the measured strain field and the simulated strain field exceeds a predetermined threshold, the operator can thus act on the intervention, for example by stopping the progression of the rod 24, or raising the rod 24 in a step for taking corrective actions 112.

Advantageously, the step 110 for determining the local geometry of the rod 24 in the well 12 is also carried out in each evolution configuration of the rod 12.

In this step 110, illustrated by FIG. 9, the measured strain field data 150 and the deployed rod length data 152 measured by the sensor 46 are introduced into the software determination module 64 to determine, during a phase 154, a calculated local geometry of the rod 24 by inversion of the second mathematical model previously described.

This calculated local geometry is next used in a phase 156 to determine, from the unwound rod length 24, measured by the sensor 46, the actual position of at least one point of the rod 24, in particular the distal end of the rod 24.

This makes it possible to deduce therefrom, in a phase 158, the exact position of the probe 26 in the well 12, in the selected evolution configuration. The precision of the correlation between the measurements done by the probe 26 and the actual position of the probe 26 is therefore greatly improved by implementing the process according to the invention.

Likewise, the sinusoidal or helical buckling zones can be viewed, which makes it possible to anticipate any difficulties during the intervention.

This limits or avoids the cases of blockage of the rod 24. Likewise, corrective actions can be taken, for example raising the rod and adding centering means in the determined zones of the rod 24, before again lowering the rod 24 into the well 12.

In the alternative illustrated by FIG. 12, the rod 24 is introduced in a first channel 170 of a well 12, and its position in the channel 170 of the well 12 is determined very precisely, as previously described.

A device 172 present in an adjacent channel 174 produces a seismic wave that is detected precisely by the probe 26. The device 172 is for example a device for fracturing the formation.

The use of an instrumented rod 24 as described above is particularly suitable for interventions in multichannel wells in which many horizontal channels are bored. It is thus possible to quickly acquire precise information by diagraphy, without significant immobilization of the well.

Owing to the invention described above, it is possible to control the evolution of a rod 24 in a well, in particular when it is lowered, much more precisely, based on richer information than just the hydraulic pressure of the injection head and the acceleration measured at the end of the rod.

It is possible to determine whether the advancement of the rod 24 and the probe 26 in the well 12 takes place in accordance with what is expected based on simulation data.

Furthermore, if the local geometry of the rod 24 is reconstituted from the measurement of the strain fields, it is possible to concretely view its evolution and localize any buckling zones that may be problematic.

This makes it possible to take corrective actions to optimize its use, by adding accessories such as centering devices, and to thereby increase the possible offset in the well 12.

In one alternative, the simulation step 100 is carried out online during the intervention.

In another alternative, the calibration step 102 is carried out during the commissioning of the rod 24, without necessarily being done at the beginning of each intervention.

1. A process for monitoring an intervention in a fluid exploitation well located in the subsoil, including:
intervening from the surface, using an instrumented rod introduced into the well, the rod comprising at least one sensor for measuring a strain field along the rod;
measuring the strain field along the rod in a plurality of given shapes of evolution of the rod during the intervention;
calculating a simulated strain field, for each given shape of the rod, based on at least one first model taking account of the predetermined geometry of the well, the first model being configured to determine a local buckling of the rod in the well;
comparing the measured strain field and the simulated strain field in each given shape of evolution of the rod.

2. The process according to claim 1, wherein the intervening includes gradually lowering the rod into the well, each given shape of evolution corresponding to an increasing length of the rod introduced into the well.

3. The process according to claim 1, wherein the local buckling of the rod is chosen from among a sinusoidal buckling and a helical buckling.

4. The process according to claim 1, wherein the first model takes account of environmental parameters of the well.

5. The process according to claim 1, wherein the first model takes account of geometric and mechanical parameters of the rod.

6. The process according to claim 1, wherein the first model takes account of the geometric position of the measuring sensor in the rod.

7. The process according to claim 1, including a prior calibration of the first model comprising:
placing the rod in a known geometric configuration,
measuring the strain field along the rod, in the known geometric configuration,
calculating a theoretical geometric configuration of the rod, based on the measured strain field,
making a comparison between the known geometric configuration and the theoretical geometric configuration, and
adjusting at least one parameter of the first model based on said comparison.

8. The process according to claim 7, wherein during the adjusting, the adjusted parameter is representative of the geometric position of the measuring sensor in the rod.

9. The process according to claim 1, including, after measuring the strain field in the given shape of evolution, determining the local geometry of the rod in the well based on the measured strain field.

10. The process according to claim 9, wherein the determining of the local geometry of the rod includes calculating the exact position of a determined point of the rod in the well based on the reconstituted local geometry of the rod.

11. The process according to claim 1, wherein the comparing includes defining an admissible strain field envelope, based on the simulated strain field, and determining an outlet of the strain field measured outside the admissible strain field envelope.

12. The process according to claim 1, including providing a composite instrumented rod comprising structural fibers and a matrix embedding the structural fibers, the measuring sensor comprising at least three optical fibers spaced angularly apart around an axis of the rod, embedded in the matrix.

13. The process according to claim 1, wherein the instrumented rod bears a probe for measuring physical or chemical parameters and/or a camera.

14. The process according to claim 1, wherein the intervening includes a first lowering of the instrumented rod into the well to a first given shape of the rod, comparing the measured strain fields and the simulated strain field in the first given shape of the, then raising the instrumented rod outside the well,
the process next including equipping the rod with trajectory correction equipment, then a second lowering of the instrumented rod into the well.

15. A device (10) for intervention in a fluid exploitation well located in the subsoil, including:
an instrumented rod able to be introduced into the well, the rod comprising at least one sensor for measuring a strain field along the rod in a plurality of shapes of evolution of the rod in the well;
a monitoring unit for monitoring the intervention comprising:
a simulator for simulating a calculated strain field, in each given shape of the rod, based on at least a first model taking account of the geometry of the well l, the first model being able to determine a local buckling of the rod in the well;
a comparator for comparing the measured strain field and the simulated strain field in each given shape.

16. The process according to claim 4, wherein the environmental parameters of the well are relative to the fluid present in the well, and/or the wall defining the well.

17. The process according to claim 5, wherein the geometric and mechanical parameters of the rod include its diameter, its linear weight, its modulus and/or its inertia.

18. The process according to claim 7, wherein the prior calibration of the first model includes placing the rod in a known geometric configuration outside the well.

19. The process according to claim 10, wherein the determined point of the rod is an end of the rod.

20. The process according to claim 13, wherein the instrumented rod bears a probe for measuring seismic data.
